(19) United States
(12) Patent Application Publication
(10) Pub. No.: US 2014/0195794 A1
(43) Pub. Date: Jul. 10, 2014

(54) ELECTRONIC DEVICE WITH BASEBOARD MANAGEMENT CONTROLLER UPDATING SYSTEM

(71) Applicants: HON HAI PRECISION INDUSTRY CO., LTD., New Taipei (CN); HONG FU JIN PRECISION INDUSTRY (ShenZhen) Co., LTD, Shenzhen (CH)

(72) Inventors: JIAN LUO, Shenzhen (CN); JIA-QING HUANG, Shenzhen (CN)

(73) Assignees: HONG FU JIN PRECISION INDUSTRY (ShenZhen) Co., LTD, Shenzhen (CN); HON HAI PRECISION INDUSTRY CO., LTD., New Taipei (TW)

(21) Appl. No.: 14/093,049

(22) Filed: Nov. 29, 2013

(30) Foreign Application Priority Data
Jan. 8, 2013 (CN) 2013100053659

(51) Int. Cl. G06F 9/44

(52) U.S. Cl. CPC G06F 9/4401
USPC 713/100

(57) ABSTRACT

A method for updating a baseboard management controller (BMC) of an electronic device, includes steps of: obtaining a sensor data record (SDR) table from a storage unit of the electronic device, the SDR table records a first kinds of sensor data and a second kind of sensor data, the second kind of sensor data includes a switch variable. Scanning the non-motherboard components of the electronic device to determine whether there is one non-motherboard component is corresponding to one of the second kind of sensor data of the SDR table, and setting the value of the switch variable of the corresponding one of the second kind of sensor to the predetermined value. Updating the sensor data of the BMC of the electronic device according to the first kind of sensor data and the second kind of sensor data whose switch variable is the predetermined value.

### BACKGROUND

1. Technical Field

The present disclosure relates to updating system, particularly, to an updating system and method for updating a baseboard management controller, and an electronic device with the updating system.

2. Description of Related Art

Nowadays, computers, such as, servers, personal computers, tablet computers, usually have a baseboard management controller (BMC). A BMC has corresponding firmware installed therein, one function of the BMC is to obtain data detected by temperature sensors, voltage sensors, fan speed sensors and determine whether the computer is working normally via the corresponding firmware. Usually, the firmware of the BMC also stores a sensor data record (SDR), the SDR records normal ranges of the temperature, the voltage, the fan speed, and other values. The BMC determines whether the data detected by the temperature sensors, the voltage sensors, the fan speed sensors is in the normal ranges recorded in the SDR to determine whether the computer is working normally. Usually, when one component of the computer is changed, such as, an old fan is changed to a different new fan, the normal range of the fan speed also needs to be changed. Therefore, it is needed to update the SDR stored in the firmware when one component of the computer is changed. However, it is often needed to update the whole firmware to update the SDR, which consumes time and is often cumbersome. Besides, in current update method, for different electronic devices, it is needed to prepare different SDR update file, if there are a number of electronic device needed to be updated, the work load is heavy.

An electronic device, a BMC updating system and method to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an electronic device with a baseboard management controller updating system, in accordance with a first embodiment.

FIG. 2 is a schematic diagram of a sensor date record table, in accordance with a first embodiment.

FIG. 3 is a flowchart illustrating a method for updating baseboard management controller, in accordance with a first embodiment.

### DETAILED DESCRIPTION

Embodiments of the present disclosure will be described with reference to the accompanying drawings. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

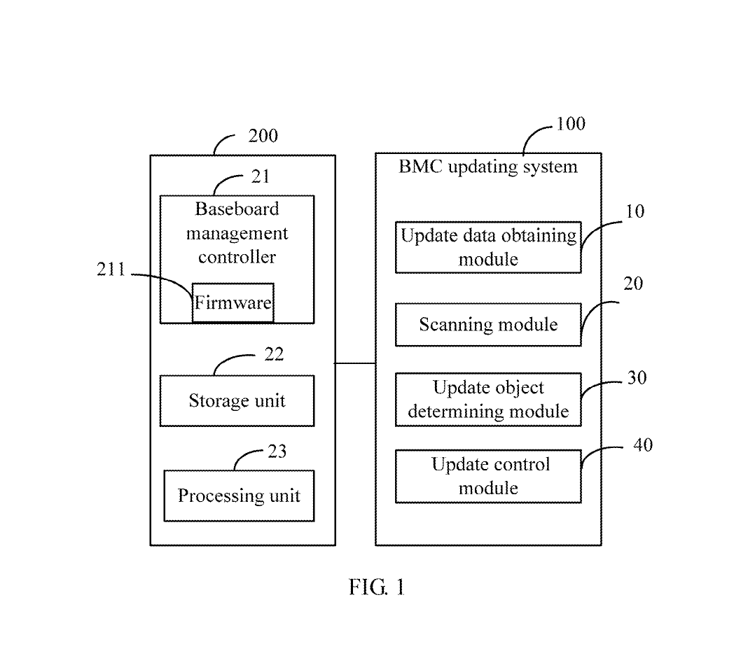

FIG. 1 shows a baseboard management controller (BMC) updating system 100. The BMC updating system 100 is used to update sensor data of a BMC 21 of an electronic device 200. The electronic device 200 also includes a storage unit 22 and a processing unit 23. The storage unit 22 can be a hard disk, a compact disk, or a flash memory, for example. The processing unit 23 can be a processor, a digital processing unit, or a single chip, for example.

The BMC updating system 100 includes an update data obtaining module 10, a scanning module 20, an update object determining module 30, and an update control module 40. In the embodiment, the BMC updating system 100 is software stored in the storage unit 22 and can be executed by the processing unit 23 of the electronic device 200. In another embodiment, the BMC updating system 100 is a program burned into the processing unit 23 and is executed by the processing unit 23.

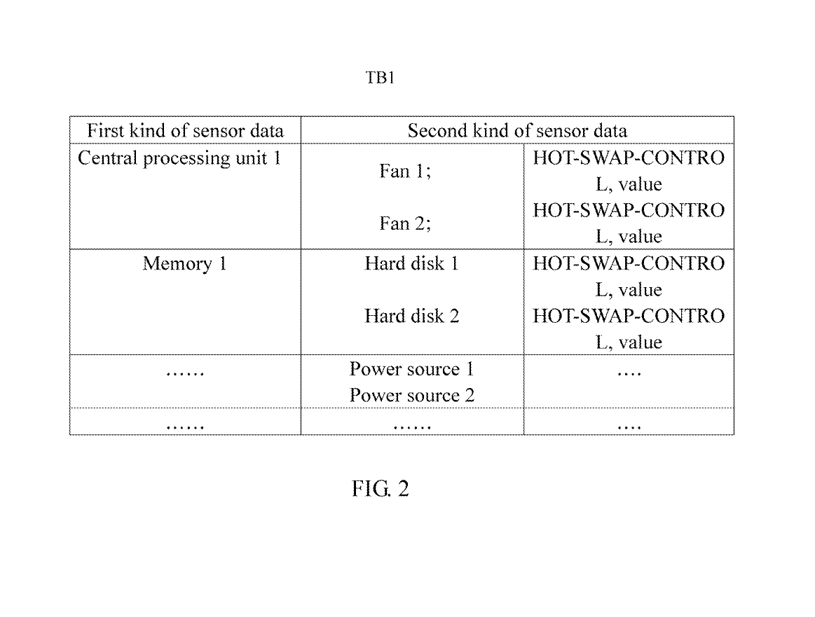

FIG. 2 shows that the update data obtaining module 10 is used to obtain a sensor data record (SDR) table TB1 from the storage unit 22 of the electronic device 200 in response to an updating operation generated by a user. The SDR table TB1 records a number of sensor data. FIG. 2 shows that the SDR table TB1 records two kinds of sensor data. A first kind of sensor data is data of motherboard components of the electronic device 200, and a second kind of sensor data is date of non-motherboard components of the electronic device 200. In the embodiment, the motherboard components include a central processing unit (CPU), a memory, and the like. The non-motherboard components include a fan, a hard disk, a power source, and the like. Here, the SDR table TB1 can be stored into the storage unit 22 in response to user operation before updating the BMC 21. The updating operation is generated by operating a particular key of a keyboard (not shown) of the electronic device 200 or selecting menu item.

The second kind of sensor data includes a switch variable, and the first kind of sensor data does not include the switch variable. Thus the first kind of sensor data and the second kind sensor data can be distinguished by determining whether the sensor data includes the switch variable.

In the embodiment, as shown in FIG. 2, the switch variable includes an identifier and a value. The identifier is used to identify the switch variable, such as, as shown in FIG. 2, the identifier is “HOT-SWAP-CONTROL”.

The scanning module 20 is used to scan the non-motherboard components of the electronic device 200, such as the fan, the hard disk of the electronic device 200 to determine if one non-motherboard component is corresponding to one of the second kind of sensor data, namely the sensor data with the switch variable, of the SDR table TB1. When the scanning module 20 determines one non-motherboard component is corresponding to one of the second kind of sensor data of the SDR table TB1, the scanning module 20 sets the value of the switch variable of the one of the second kind of sensor to a predetermined value, such as “1”.

In the embodiment, each one of the first kind of sensor data and the second kind of sensor data of the SDR table TB1 includes a unique code of a corresponding component. The scanning module 20 compares the unique codes of the non-motherboard components of the electronic device 200 with the unique codes of the sensor data. In addition, determines the non-motherboard component with the same unique code as that of one of the second kind of sensor data is corresponding to the one of the second kind of sensor data of the SDR table TB1.

The update object determining module 30 determines the sensor data of the SDR table TB1 without the switch variable is the first kind of sensor data, and determines the first kind of sensor data and the second kind of sensor data whose switch variable is the predetermined value are sensor data to be used to update. In detail, as described above, the switch variable of each one of the second kind of sensor data includes the identifier and the value, the update object determining module 30 determines whether the sensor data is the second kind of data by determining whether the sensor data includes the identifier. That is, when the update object determining module 30 determines the sensor data includes the identifier, the update object determining module 30 determines the sensor data is the second kind of sensor data, otherwise, the update object determining module 30 determines the sensor data is the first kind of sensor data. The update object determining module 30 then determines whether the value of the switch variable of the second kind of sensor data is the predetermined value, if yes, the update object determining module 30 determines the second kind of sensor data is to be used to update.

The update control module 40 is used to update the sensor data of the BMC 21 of the electronic device 200 according to the sensor data of the SDR table TB1 to be used to update. In detail, the update control module 40 determines the sensor data of the BMC 21 corresponding to the sensor data of the SDR table TB1 is/are to be used to update, and replaces the sensor data of the firmware of the BMC 21 by using the corresponding determined sensor data to be used to update.

In the embodiment, the first kind of sensor data and the second kind of sensor data recorded in the SDR table TB1 can be changed by a user, such as an operator. The user can edit the SDR table TB1 according to the sensor data, needed to be updated, of a number of electronic devices 200. When the number of electronic devices 200 has the same motherboard components, thus, the first kind of the sensor data of the electronic devices 200 are the same, the SDR table TB1 only needs to record the first kind of sensor of any one of the electronic devices 200. The SDR table TB1 also records the second kind of sensor data of the different electronic devices 200. As described above, the scanning module 20 sets the value of the switch variable of the one of the second kind of sensor to the predetermined value when determining one non-motherboard component of current electronic device 200 is corresponding to one of the second kind of sensor data of the SDR table TB1. The update object determining module 30 then determines the first kind of sensor data and the second kind of sensor data of the SDR table TB1 whose switch variable is the predetermined value are the sensor data to be used to update for the current electronic device 200.

In the embodiment, the BMC 21 includes a firmware 211, the sensor data is stored in the firmware 211 of the BMC 21. In the embodiment, only the sensor data of the BMC 21 of the electronic device 200 corresponding to the sensor data to be used to update are needed to be updated, thus, it is not needed to update the whole firmware 211 of the BMC 21. Besides, for the electronic devices 200 including the same motherboard components and different non-motherboard components, it is only needed to prepare one SDR table TB1 to update the all of electronic devices.

In the embodiment, the electronic device 200 can be a tablet computer, a desktop computer, a portable computer, or a server.

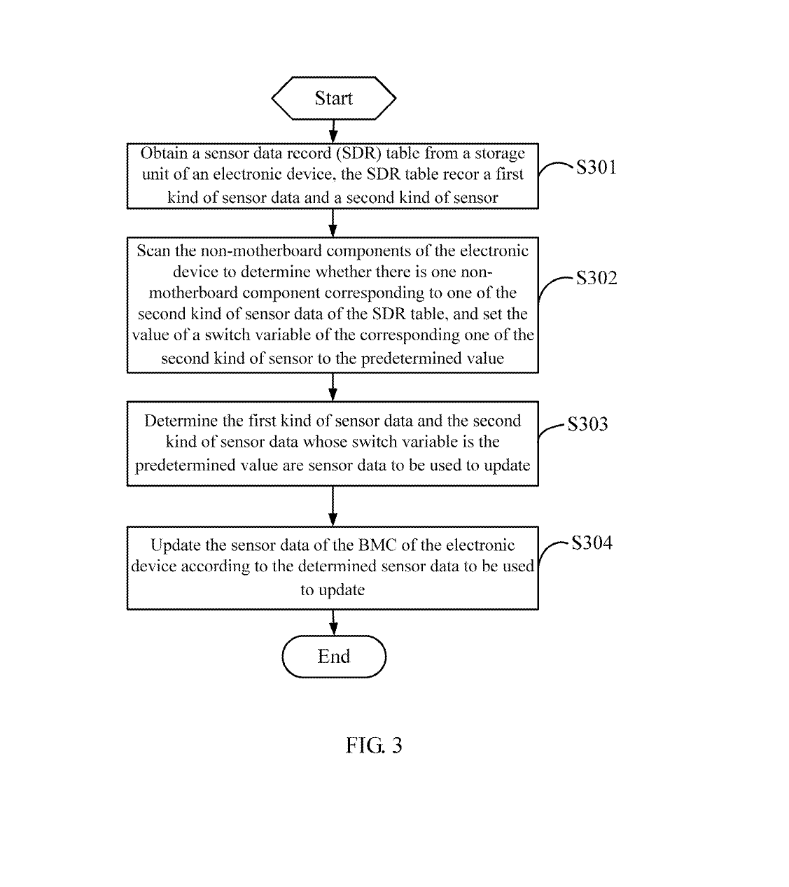

FIG. 3 illustrates a method for updating the BMC 21 of the electronic device 200.

At first, the update data obtaining module 10 obtains a sensor data record (SDR) table TB1 from the storage unit 22 of the electronic device 200 in response to an updating operation. At this time, the SDR table TB1 records two kinds of sensor data, the first kind of sensor data is data of motherboard components of the electronic device 200. The second kind of sensor data is date of non-motherboard components of the electronic device 200, each of the second kind of sensor data includes a switch variable. The first kind of sensor data does not include the switch variable (S301).

The scanning module 20 scans the non-motherboard components of the electronic device 200 to determine if there is one non-motherboard component corresponding to one of the second kind of sensor data of the SDR table TB1, and sets the value of the switch variable of the corresponding one of the second kind of sensor to the predetermined value when determining one non-motherboard component is corresponding to one of the second kind of sensor data of the SDR table TB1 (S302). In detail, each one of the first kind of sensor data and the second kind of sensor data of the SDR table TB1 includes a unique code of a corresponding component. The scanning module 20 compares the unique codes of the non-motherboard components of the electronic device 200 and the unique codes of the sensor data and determine the non-motherboard component with the same unique code as that of one of the second kind of sensor data is corresponding to the one of the second kind of sensor data of the SDR table TB1.

The update object determining module 30 determines the first kind of sensor data and the second kind of sensor data whose switch variable with the predetermined value is sensor data to be used to update (S303).

The update control module 40 updates the sensor data of the BMC 21 of the electronic device 200 according to the determined sensor data to be used to update (S304). In detail, the update control module 40 determines the sensor data of the BMC 21 corresponding to the sensor data of to be used to update, and replaces the sensor data of the firmware of the BMC 21 by using the sensor data to be used to update.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A baseboard management controller (BMC) updating system, configured for updating sensor data of a BMC of an electronic device, wherein the BMC updating system comprising:
an update data obtaining module configured to obtain a sensor data record (SDR) table from a storage unit of the electronic device in response to an updating operation, wherein, the SDR table records two kinds of sensor data, a first kind of sensor data are data of motherboard components of the electronic device, and a second kind of sensor data are date of non-motherboard components of the electronic device, each of the second kind of sensor data includes a switch variable, and the first kind of sensor data does not include the switch variable;
a scanning module configured to scan the non-motherboard components of the electronic device to determine whether there is one non-motherboard component corresponding to one of the second kind of sensor data of the SDR table, and set the value of the switch variable of the corresponding one of the second kind of sensor to the predetermined value when determining one non-motherboard component is corresponding to one of the second kind of sensor data of the SDR table;
an update object determining module configured to determine the first kind of sensor data and the second kind of sensor data whose switch variable is the predetermined value are sensor data to be used to update; and
an update control module configured to update the sensor data of the BMC of the electronic device according to the determined sensor data to be used to update;
wherein, the BMC updating system is executed by a processing unit of the electronic device.

2. The system according to claim 1, wherein each one of the first kind of sensor data and the second kind of sensor data of the SDR table comprises a unique code of a corresponding component, the scanning module compares the unique codes of the non-motherboard components of the electronic device with the unique codes of the sensor data and determines the non-motherboard component with the same unique code as that of one of the second kind of sensor data is corresponding to the one of the second kind of sensor data of the SDR table.

3. The system according to claim 1, wherein the switch variable of each one of the second kind of sensor data comprises an identifier and a value, the update object determining module determines whether the sensor data is the first kind of data or the second kind of data by judging whether the sensor data comprises the identifier.

4. The system according to claim 1, wherein the update control module updates the sensor data of the BMC of the electronic device according to the determined sensor data to be used to update comprises: the update control module determines the sensor data of the BMC corresponding to the sensor data of the SDR table is/are to be used to update, and replaces the sensor data of the firmware of the BMC by using the sensor data to be used to update.

5. An electronic device comprising:
a baseboard management controller (BMC) storing sensor data;
a storage unit storing a sensor data record (SDR) table, wherein, the SDR table records two kinds of sensor data, a first kind of sensor data are data of motherboard components of the electronic device, and a second kind of sensor data are date of non-motherboard components of the electronic device, each of the second kind of sensor data includes a switch variable, and the first kind of sensor data does not include the switch variable; and
a processing unit executing a BMC updating system, wherein, the BMC updating system comprises:
a update data obtaining module configured to obtain the SDR table from the storage unit in response to an updating operation;
a scanning module configured to scan the non-motherboard components of the electronic device to determine whether there is one non-motherboard component corresponding to one of the second kind of sensor data of the SDR table, and set the value of the switch variable of the corresponding one of the second kind of sensor to the predetermined value when determining one non-motherboard component is corresponding to one of the second kind of sensor data of the SDR table;
an update object determining module configured to determine the first kind of sensor data and the second kind of sensor data whose switch variable is the predetermined value are sensor data to be used to update; and
an update control module configured to update the sensor data of the BMC of the electronic device according to the determined sensor data to be used to update.

6. The electronic device according to claim 5, wherein each one of the first kind of sensor data and the second kind of sensor data of the SDR table comprises a unique code of a corresponding component, the scanning module compares the unique codes of the non-motherboard components of the electronic device with the unique codes of the sensor data and determines the non-motherboard component with the same unique code as that of one of the second kind of sensor data is corresponding to the one of the second kind of sensor data of the SDR table.

7. The electronic device according to claim 5, wherein the switch variable of each one of the second kind of sensor data comprises an identifier and a value, the update object determining module determines whether the sensor data is the first kind of data or the second kind of data by judging whether the sensor data comprises the identifier.

8. The electronic device according to claim 5, wherein the update control module updates the sensor data of the BMC of the electronic device according to the determined sensor data to be used to update comprises: the update control module determines the sensor data of the BMC corresponding to the sensor data of the SDR table is/are to be used to update, and replaces the sensor data of the firmware of the BMC by using the sensor data to be used to update.

9. The electronic device according to claim 5, wherein the electronic device is a tablet computer, a portable computer, a desktop computer, or a server.

10. A method for updating a baseboard management controller (BMC) of an electronic device, comprising:
obtaining a sensor data record (SDR) table from a storage unit of the electronic device in response to an updating operation, wherein, the SDR table records two kinds of sensor data, a first kind of sensor data are data of motherboard components of the electronic device, and a second kind of sensor data are date of non-motherboard components of the electronic device, each of the second kind of sensor data comprises a switch variable, and the first kind of sensor data does not comprises the switch variable;
scanning the non-motherboard components of the electronic device to determine whether there is one non-motherboard component corresponding to one of the second kind of sensor data of the SDR table, and setting the value of the switch variable of the corresponding one of the second kind of sensor to the predetermined value if yes;
determining the first kind of sensor data and the second kind of sensor data whose switch variable is the predetermined value are sensor data to be used to update; and
updating the sensor data of the BMC of the electronic device according to the determined sensor data to be used to update.

11. The method according to claim 10, wherein the step of scanning the non-motherboard components of the electronic device to determine whether there is one non-motherboard component is corresponding to one of the second kind of sensor data of the SDR table comprises:
scanning the non-motherboard components of the electronic device;
comparing unique codes of the non-motherboard components of the electronic device with unique codes of the sensor data; and
determining the non-motherboard component with the same unique code as that of one of the second kind of sensor data is corresponding to the one of the second kind of sensor data of the SDR table.

12. The method according to claim 10, wherein the step of updating the sensor data of the BMC of the electronic device according to the determined sensor data to be used to update comprises:
determining the sensor data of the BMC corresponding to the sensor data of the SDR table is/are to be used to update, and
replacing the sensor data of the firmware of the BMC by using the sensor data to be used to update.
